(19) United States
(12) Patent Application Publication
(10) Pub. No.: US 2013/0109429 A1
(43) Pub. Date: May 2, 2013

(54) Interference Management

(71) Applicants: Agnieszka Szufarska, Gdansk (PL); Klaus Ingemann Pedersen, Aalborg (DK)

(72) Inventors: Agnieszka Szufarska, Gdansk (PL); Klaus Ingemann Pedersen, Aalborg (DK)

(21) Appl. No.: 13/643,752

(22) PCT Filed: Apr. 29, 2010
(86) PCT No.: PCT/EP2010/055783

§ 371 Date: Dec. 26, 2012

(51) Int. Cl. H04W 52/24

(52) U.S. Cl. CPC H04W 52/241
USPC 455/522

(57) ABSTRACT

A technique of determining whether or not to limit the wireless transmission power of a first access node serving a first area within a second area served by a second access node, wherein the first and second access node share at least some frequency resources; wherein the determining is based on an indicator of the number of other access nodes operating within a predetermined range of said first access node that also share at least some frequency resources with said second access node and serve further areas within said second area.

The present invention relates to managing interference in a system where access nodes share at least some frequency resources for wireless transmissions to and from communication devices. In one embodiment, it relates to managing interference in a heterogeneous system comprising a macro access node serving a relatively wide area and one or more femto access nodes serving respective smaller areas within the relatively wide area served by the macro access node.

A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

A communication system is a facility which facilitates the communication between two or more entities such as the communication devices, network entities and other nodes. A communication system may be provided by one or more interconnect networks. One or more gateway nodes may be provided for interconnecting various networks of the system. For example, a gateway node is typically provided between an access network and other communication networks, for example a core network and/or a data network.

An appropriate access system allows the communication device to access to the wider communication system. An access to the wider communications system may be provided by means of a fixed line or wireless communication interface, or a combination of these. Communication systems providing wireless access typically enable at least some mobility for the users thereof. Examples of these include wireless communications systems where the access is provided by means of an arrangement of cellular access networks. Other examples of wireless access technologies include different wireless local area networks (WLANs) and satellite based communication systems.

A wireless access system typically operates in accordance with a wireless standard and/or with a set of specifications which set out what the various elements of the system are permitted to do and how that should be achieved. For example, the standard or specification may define if the user, or more precisely user equipment, is provided with a circuit switched bearer or a packet switched bearer, or both. Communication protocols and/or parameters which should be used for the connection are also typically defined. For example, the manner in which communication should be implemented between the user equipment and the elements of the networks and their functions and responsibilities are typically defined by a predefined communication protocol. Such protocols and or parameters further define the frequency spectrum to be used by which part of the communications system, the transmission power to be used etc.

In the cellular systems a network entity in the form of a base station provides a node for communication with mobile devices in one or more cells or sectors. It is noted that in certain systems a base station is called ‘Node B’. Typically the operation of a base station apparatus and other apparatus of an access system required for the communication is controlled by a particular control entity. The control entity is typically interconnected with other control entities of the particular communication network. Examples of cellular access systems include GSM (Global System for Mobile) EDGE (Enhanced Data for GSM Evolution) Radio Access Networks (GERAN), Universal Terrestrial Radio Access Networks (UTRAN), and evolved Universal Terrestrial Radio Access Networks (EUTRAN).

A radio access network managed by an operator may be a heterogeneous network comprising a plurality of low power access nodes designed to provide data services to communication devices within a relatively small geographical area within a relatively wide geographical area served by a higher power access node, wherein the low power access nodes and the high power access node share at least some frequency resources. Examples of higher power access nodes are macro access nodes such as cellular network base stations operating according to a Long Term Evolution-Advanced (LTE-A) standard (LTE-A eNBs). Examples of low power access nodes include Closed Subscriber Group (CSG) Home eNBs also operating according to a LTE-A standard (CSG-HeNBs).

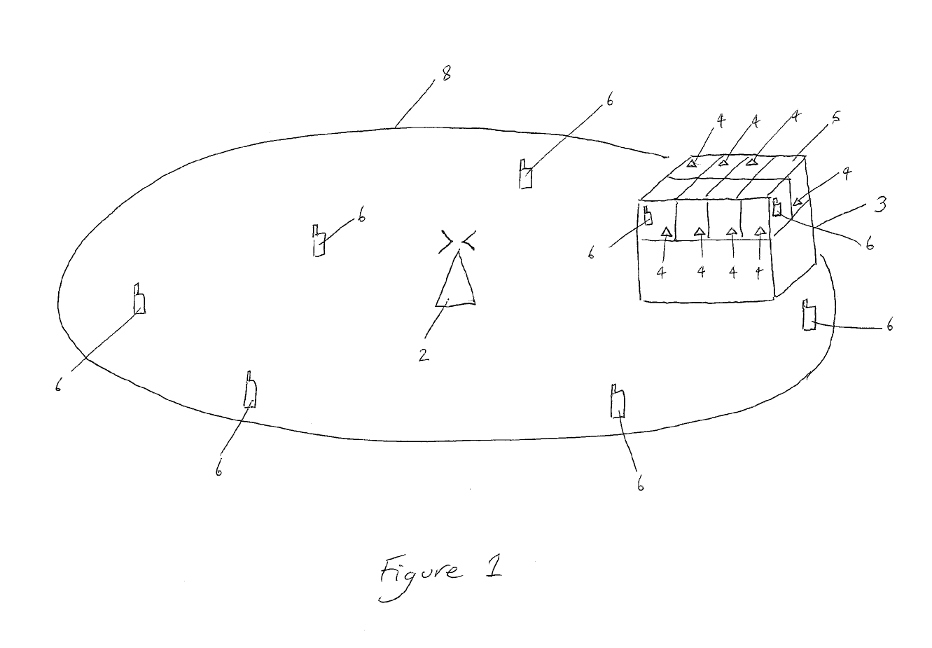

One simple example of such a heterogeneous network is illustrated in FIG. 1. A LTE-A base station (eNB) 2 serves communication devices 6 within a relatively wide area 8. Within this area is an apartment building 3 in which a CSG HeNB 4 is provided in some or all of the apartments 5. The LTE-A base station 2 will typically be one of a large number of LTE-A base stations forming part of a cellular network. Likewise, the area served by each LTE-A base station will typically include a large number of CSG HeNBs. FIG. 1 shows one floor of the apartment building with a respective CSG HeNB 4 in each of the eight apartments 5 situated on one floor of the apartment building. Because the LTE-A base station and the CSG HeNBs share frequency resources, there is a concern that transmissions made by such CSG HeNBs 4 at the edge of the area 8 served by the LTE-A base station 2 (where the received signal power from the LTE-A base station 2 is relatively weak) might make it difficult for the LTE-A base station 2 to serve a communication device located close to the CSG HeNBs. If this communication device is not a member of the CSG of the closest CSG HeNB and is therefore also not served by the closest CSG HeNB, then there is a risk that the communication device cannot be served by any access node.

One technique for managing interference in this kind of situation is to allocate to LTE-A base station 2 some frequency resources that are not available to the CSG HeNBs 4. For example, the network might be configured such that the LTE-A base station 2 is able to use two different LTE-A component carriers F1 and F2 for its transmissions, whereas each CSG HeNBs 4 only uses one of these two carriers. Where a communication device served by LTE-A base station 2 is in the close vicinity of a CSG HeNB 4, the LTE-A base station 2 can avoid interference from that CSG HeNB's transmissions by communicating with that communication device using the one of the two carriers F1 and F2 that the CSG HeNB 4 does not use. Another technique involves limiting the transmission power of CSG HeNBs 4 depending on their location in the area served by the LTE-A base station 2. For example, those CSG HeNBs located at the outer portion of the area served by the LTE-A base station 2 are subject to the strictest limitations on their transmission power, whereas CSG HeNBs located close to the LTE-A base station 2 are subject to the least limitations on their transmission power.

It is an aim of the present invention to provide an improved technique for managing interference in a heterogeneous network.

The present invention provides a method, comprising: determining whether or not to limit the wireless transmission power of a first access node serving a first area within a second area served by a second access node, wherein the first and second access node share at least some frequency resources; wherein the determining is based on an indicator of the number of other access nodes operating within a predetermined range of said first access node that also share at least some frequency resources with said second access node and serve further areas within said second area.

In one embodiment, the determining is also based on whether or not the frequency resources available to said second access node include frequency resources not available to said first access node; and it is determined to limit the trans-mission power of said first access node if (i) the frequency resources available to said second access node do include frequency resources not available to said first access node, and (ii) said indicator is not lower than a predetermined threshold number; and it is determined not to limit the transmission power of said first access node if (i) the frequency resources available to said second access node do include frequency resources not available to said first access node, and (ii) said indicator is lower than a predetermined threshold number.

In one embodiment, said first access node is located in an outer portion of said second area.

In one embodiment, the determining is also based on the location of the first access node in relation to the second access node.

The present invention also provides an apparatus configured to carry out the method of the present invention.

The present invention also provides an apparatus comprising: a processor and memory including computer program code, wherein the memory and the computer program are configured to, with the processor, cause the apparatus at least to carry out the method of the present invention.

The present invention also provides a computer program product comprising program code means which when loaded into a computer controls the computer to perform the method of the present invention.

The present invention also provides a system comprising: a first access node and a second access node, wherein the first access node serves a first area within a second area served by the second access node; wherein the first and second access node share at least some frequency resources; and wherein the second access node is configured to determine whether or not to limit the wireless transmission power thereof based on an indicator of the number of other access nodes operating within a predetermined range of said first access node that also share at least some frequency resources with said second access node and serve further areas within said second area.

Hereunder an embodiment of the present invention will be described, by way of example only, with reference to the following drawings, in which:

FIG. 1 illustrates a heterogeneous network within which an embodiment of the invention may be implemented, which network includes a LTE-A base station serving a relatively wide area and CSG-HeNBs serving respective smaller areas within the area served by the LTE-A base station.

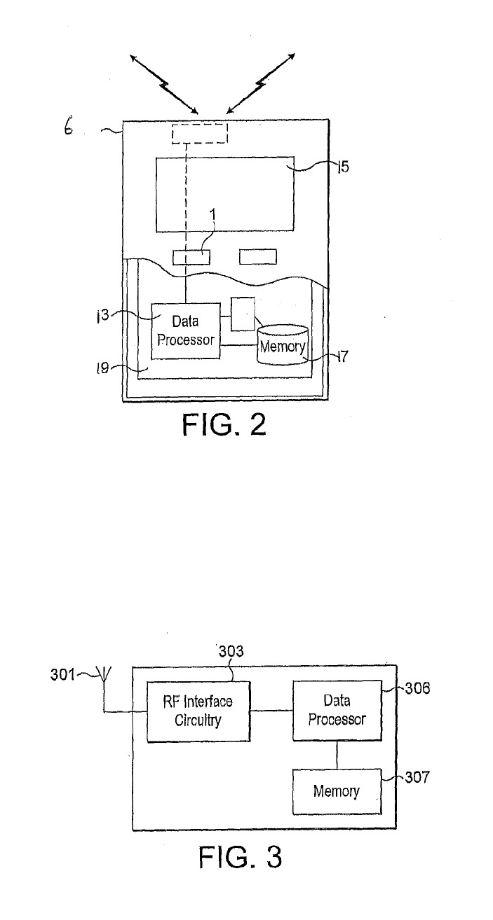

FIG. 2 illustrates a user equipment shown in FIG. 1 in further detail;

FIG. 3 illustrates an apparatus suitable for implementing an embodiment of the invention at a CSG HeNB of the network shown in FIG. 1; and

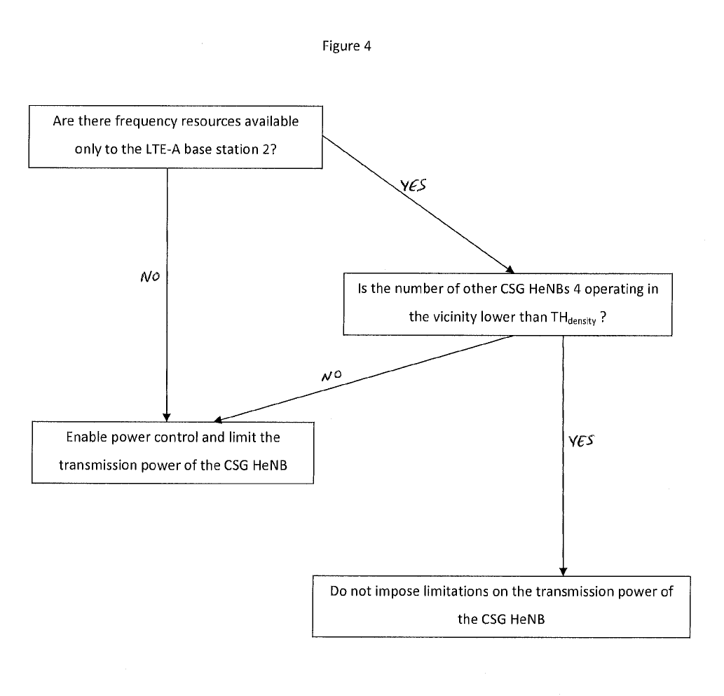

FIG. 4 illustrates a method of operating a CSG HeNB in FIG. 1 in accordance with an embodiment of the present invention.

FIG. 1 is described above. A LTE-A network has been chosen to describe an embodiment of the invention; but the invention is also of use in other networks, such as networks including High Speed Packet Access (HSPA) Femto cells.

FIG. 2 shows a schematic partially sectioned view of an example of user equipment 6 that may be used for communicating with the LTE-A base station 2 and/or a CSG HeNB 4 of FIG. 1 via a wireless interface. The user equipment (UE) 6 may be used for various tasks such as making and receiving phone calls, for receiving and sending data from and to a data network and for experiencing, for example, multimedia or other content.

The UE 6 may be any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The UE 6 may communicate via an appropriate radio interface arrangement of the UE 6. The interface arrangement may be provided for example by means of a radio part and associated antenna arrangement. The antenna arrangement may be arranged internally or externally to the UE 6.

The UE 6 may be provided with at least one data processing entity 13 and at least one memory or data storage entity 17 for use in tasks it is designed to perform. The data processor 13 and memory 17 may be provided on an appropriate circuit board 19 and/or in chipsets.

The user may control the operation of the UE 6 by means of a suitable user interface such as key pad 1, voice commands, touch sensitive screen or pad, combinations thereof or the like. A display 15, a speaker and a microphone may also be provided. Furthermore, the UE 6 may comprise appropriate connectors (either wired or wireless) to other devices and/or for connecting external accessories, for example hands-free equipment, thereto.

FIG. 3 shows an example of apparatus for use at either the CSG HeNBs 4 or at the LTE-A base station 2. The apparatus comprises a radio frequency antenna 301 configured to receive and transmit radio frequency signals; radio frequency interface circuitry 303 configured to interface the radio frequency signals received and transmitted by the antenna 301 and the data processor 306. The radio frequency interface circuitry 303 may also be known as a transceiver. The data processor 306 is configured to process signals from the radio frequency interface circuitry 303, control the radio frequency interface circuitry 303 to generate suitable RF signals to communicate information to the UE 6 via the wireless communications link. The memory 307 is used for storing data, parameters and instructions for use by the data processor 306.

It would be appreciated that both the UE 6 and the apparatus shown in FIGS. 2 and 3 respectively and described above may comprise further elements which are not directly involved with the embodiments of the invention described hereafter.

In this embodiment, LTE-A base station 2 is designed to make OFDM (Orthogonal Frequency Division Multiple Access) trans-missions on one or more LTE component carriers, which component carriers are made up of groups of orthogonal subcarriers. Each CSG-HeNB 4 is also designed to make OFDM transmissions on one or more of the one or more LTE component carriers on which the LTE-A base station makes transmissions. Where the LTE-A base station 2 does have the option to make a transmission on an LTE component carrier that is not available to the CSG HeNBs 4 at the edge of the area 8 served by the macro access node 2 (such carrier can be referred to as an “escape carrier”), the inventors have found that it can be advantageous to switch between limiting the transmission power of a CSG HeNB 4 and not limiting the transmission power of a CSG HeNB 4 depending on the density of operating CSG HeNBs 4 in the vicinity of the said CSG-HeNB. In other words, where the density of CSG HeNBs 4 is relatively high, the performance of the LTE-A base station 2 can be improved by limiting the transmission power of the CSG HeNBs 4; on the other hand, where the density of operating CSG HeNBs 4 is relatively low, the performance of both the LTE-A base station 2 and the CSG HeNBs 4 can be improved by not limiting the transmission power of the CSG HeNBs 4. For the case where LTE-A base station 2 does not have the option to make a transmission on an LTE component carrier that is not available to the CSG HeNBs 4 (i.e. there is no escape carrier) it is found that there may be no disadvantage to always limiting the transmission power of a CSG HeNB 4 irrespective of the density of CSG HeNBs.

FIG. 4 illustrates the operation of a CSG HeNB 4 in accordance with an embodiment of the present invention.

In STEP 400, the CSG HeNB 4 checks if there are frequency resources (e.g. one or more escape carriers) available only to the LTE-A base station 2 (i.e. not to the CSG HeNBs 4) for the protection of the LTE-A base station 2. This check can be made on the basis of information received from a centralised management system servicing a group of CSG HeNBs 4 or obtained autonomously by measurements done either by the HeNB or any UE connected to it.

If the result of the check is negative, the CSG HeNB 4 enables power control and limits the transmission power of the CSG HeNB in accordance with a power control formula (STEP 402).

If the result of the check is positive, the CSG HeNB 4 determines the number of other CSG HeNBs 4 operating in the vicinity (STEP 404). The CSG-HeNB does this by either (a) itself measuring the power at which it detects reference signals from other CSG HeNBs 4 and counting the number of CSG-HeNBs 4 for which the detected reference signal received power (RSRP) exceeds a predetermined threshold power, TH_{power}; or (b) receiving such RSRP measurements from one or more UEs connected to the CSG HeNB and counting the number of CSG-HeNBs 4 for which the RSRP exceeds said predetermined threshold power TH_{power}. The threshold power TH_{power} may be set at the CSG-HeNB 4 or may be a value that is received from a centralised entity that provides operations and maintenance information to a group of CSG HeNBs 4.

If the number of CSG-HeNBs 4 for which the RSRP is lower than a certain threshold, TH_{density}, the CSG-HeNB 4 does not impose limitations on its transmission power (STEP 406).

On the other hand, if the number of CSG-HeNBs 4 for which the RSRP is not lower than said certain threshold, TH_{density}, the CSG-HeNB 4 limits its transmission power according to a power control formula (STEP 408).

The values of TH_{threshold} and TH_{density} can be dynamically set by the operator of the heterogeneous network according to any change in the priority that it wishes to give to improving the level of performance of the LTE-A base station.

The above-described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Califormia automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication. In addition to the modifications explicitly mentioned above, it will be evident to a person skilled in the art that various other modifications of the described embodiment may be made within the scope of the invention.

1. A method, comprising: determining whether or not to limit the wireless transmission power of a first access node serving a first area within a second area served by a second access node, wherein the first and second access node share at least some frequency resources; wherein the determining is based on an indicator of the number of other access nodes operating within a predetermined range of said first access node that also share at least some frequency resources with said second access node and serve further areas within said second area.

2. A method according to claim 1, wherein the determining is also based on whether or not the frequency resources available to said second access node include frequency re-sources not available to said first access node.

3. A method according to claim 2, comprising determining to limit the transmission power of said first access node if (i) the frequency resources available to said second access node do include frequency resources not available to said first access node, and (ii) said indicator is not lower than a predetermined threshold number.

4. A method according to claim 2, comprising determining not to limit the transmission power of said first access node if (i) the frequency resources available to said second access node do include frequency resources not available to said first access node, and (ii) said indicator is lower than a predetermined threshold number.

5. A method according to claim 1, wherein said first access node is located in an outer portion of said second area.

6. A method according to claim 1, wherein the determining is also based on the location of the first access node in relation to the second access node.

7. An apparatus configured to carry out the method of claim 1.

8. An apparatus comprising: a processor and memory including computer program code, wherein the memory and the computer program are configured to, with the processor, cause the apparatus at least to carry out the method of claim 1.

9. A computer program product comprising program code means which when loaded into a computer controls the computer to perform a method according to claim 1.

10. A system comprising: a first access node and a second access node, wherein the first access node serves a first area within a second area served by the second access node; wherein the first and second access node share at least some frequency resources; and wherein the second access node is configured to determine whether or not to limit the wireless transmission power thereof based on an indicator of the number of other access nodes operating within a predetermined range of said first access node that also share at least some frequency resources with said second access node and serve further areas within said second area.
